(19) United States
(12) Patent Application Publication
(10) Pub. No.: US 2019/0302556 A1
(43) Pub. Date: Oct. 3, 2019

(54) LIQUID CRYSTAL DISPLAY DEVICE

(71) Applicant: Samsung Display Co., Ltd., Yongin-si (KR)

(72) Inventors: Dong Hee SHIN, Asan-si (KR); Yoo Mi RA, Ansan-si (KR); Hyung Jin SONG, Hwaseong-si (KR); Soo Hong CHEON, Seoul (KR)

(21) Appl. No.: 16/260,106

(22) Filed: Jan. 29, 2019

(30) Foreign Application Priority Data
Mar. 29, 2018 (KR) 10-2018-0036820

(51) Int. Cl. G02F 1/1362; G09G 3/36; G02F 1/1343

(52) U.S. Cl. CPC G02F 1/136286; G02F 1/13624; G02F 1/136277; G09G 3/3677; G09G 3/3688; G09G 2300/0809; G02F 2001/136222; G02F 2201/123; G09G 2310/08; G09G 2300/0426; G09G 2300/0465; G02F 1/134309

(57) ABSTRACT

A liquid crystal display device including a first pixel electrode including a first stem extending in a first direction, a second stem connected to the first stem and extending in a second direction intersecting the first direction, a third stem connected to the first stem and extending in the second direction, a plurality of first branches extending from the second stem toward the third stem, and a plurality of second branches extending from the third stem toward the second stem; a first data line extending in the second direction and overlapping the second stem; a second data line extending in the second direction and overlapping the plurality of first branches and the plurality of second branches; a first scan line extending in the first direction; and a first switching element including a control electrode connected to the first scan line, a first electrode connected to the first data line, and a second electrode connected to the first pixel electrode.

### CROSS-REFERENCE TO RELATED APPLICATION

This application claims priority from and the benefit of Korean Patent Application No. 10-2018-0036820, filed on Mar. 29, 2018, which is hereby incorporated by reference for all purposes as if fully set forth herein.

### BACKGROUND

### Field

Exemplary embodiments of the invention relate to a liquid crystal display device.

### Discussion of the Background

The importance of a display device has increased with the development of multimedia. Accordingly, various types of display devices, such as a liquid crystal display (LCD) and an organic light emitting display (OLED), have been used.

Among display devices, a liquid crystal display device, which is one of the most widely used flat panel display devices, includes two substrates including electric field generating electrodes, such as a pixel electrode and a common electrode, and a liquid crystal layer disposed therebetween. In the liquid crystal display device, a voltage is applied to the electric field generating electrodes to form an electric field in the liquid crystal layer, so that the alignment of liquid crystal molecules in the liquid crystal layer is determined, and the polarization of incident light is controlled, thereby displaying an image.

The above information disclosed in this Background section is only for understanding of the background of the inventive concepts, and, therefore, it may contain information that does not constitute prior art.

### SUMMARY

Exemplary embodiments of the present invention provide a liquid crystal display device which can perform high-resolution driving, and has a low aperture ratio loss.

Additional features of the inventive concepts will be set forth in the description which follows, and in part will be apparent from the description, or may be learned by practice of the inventive concepts.

An exemplary embodiment of the present invention provides a liquid crystal display device, including a first pixel electrode including a first stem extending in a first direction, a second stem connected to the first stem and extending in a second direction intersecting the first direction, a third stem connected to the first stem and extending in the second direction, a plurality of first branches extending from the second stem toward the third stem, and a plurality of second branches extending from the third stem toward the second stem; a first data line extending in the second direction and overlapping the second stem; a second data line extending in the second direction and overlapping the plurality of first branches and the plurality of second branches; a first scan line extending in the first direction; and a first switching element including a control electrode connected to the first scan line, one electrode connected to the first data line, and the other electrode connected to the first pixel electrode.

Another exemplary embodiment of the present invention provides a liquid crystal display device, including a first pixel electrode including a first stem extending in a first direction, a second stem connected to the first stem and extending in a second direction intersecting the first direction, a third stem connected to the first stem and extending in the second direction, a plurality of first branches extending from the second stem to be connected to the third stem, and a plurality of second branches extending from the third stem to extend in a direction symmetrical to the extension direction of the plurality of first branches; a first data line extending in the second direction and overlapping the second stem; and a second data line extending in the second direction and overlapping the third stem.

Another exemplary embodiment of the present invention provides a liquid crystal display device including a first pixel electrode including a first stem extending in a first direction, a second stem connected to the first stem and extending in a second direction intersecting the first direction, an edge bar connected to the first stem and extending in the second direction, and a plurality of first branches extending from the second stem to extend in a direction in which the edge bar is disposed; a first data line extending in the second direction and overlapping the second stem; a second data line extending in the second direction and overlapping the plurality of first branches; a first scan line extending in the first direction; and a first switching element including a control electrode connected to the first scan line, one electrode connected to the first data line, and the other electrode connected to the first pixel electrode.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 is a block diagram schematically showing a liquid crystal display device according to an exemplary embodiment of the present invention.

FIG. 2 is an equivalent circuit diagram of first to fourth pixel units shown in FIG. 1.

FIG. 3A is a layout view showing the first to fourth pixel units shown in FIG. 1.

FIG. 3B is a view more specifically showing the first pixel unit PX1 shown in FIG. 3A.

FIG. 4 is a view showing a gate conductor included in the first pixel unit shown in FIG. 3B.

FIG. 5 is a view showing a data conductor included in the first pixel unit shown in FIG. 3B.

FIG. 6 is a view showing a transparent conductor included in the first pixel unit shown in FIG. 3B.

FIG. 7 is a cross-sectional view taken along the line I1-I1′ shown in FIG. 3B.

FIG. 8A is a cross-sectional view taken along the line I2-I2′ shown in FIG. 3B, and FIG. 8B is a cross-sectional view taken along the line I3-I3′ shown in FIG. 3B.

FIG. 9 is a view showing both a data conductor and a transparent conductor of the first pixel unit shown in FIG. 3B.

FIG. 10 is an equivalent circuit diagram of a liquid crystal display device according to another exemplary embodiment of the present invention.

FIG. 11A and FIG. 11B are layout views showing pixel units included in a liquid crystal display device according to still another exemplary embodiment of the present invention.

FIG. 12 is a view showing a transparent conductor included in the pixel unit shown in FIG. 11.

FIG. 13 is a view showing both a data conductor and a transparent conductor included in the pixel unit shown in FIG. 11.

FIG. 14A is a layout view showing first to fourth pixel units included in the liquid crystal display device according to still another exemplary embodiment of the present invention.

FIG. 14B is a view more specifically showing the first pixel unit shown in FIG. 14A.

FIG. 15 is a view showing a transparent conductor included in the first pixel unit shown in FIG. 14B.

FIG. 16 is a layout view showing a liquid crystal display device according to another exemplary embodiment of the present invention.

FIG. 17 is an equivalent circuit diagram of a first pixel unit included in a liquid crystal display device according to still another exemplary embodiment of the present invention.

FIG. 18A is a layout view more specifically showing the first pixel unit shown in FIG. 17.

FIG. 18B is a layout view showing first to fourth pixel units including the first pixel unit shown in FIG. 17.

FIG. 19 is a view showing both a first sub-pixel electrode and a second sub-pixel electrode shown in FIG. 18A.

### DETAILED DESCRIPTION

In the following description, for the purposes of explanation, numerous specific details are set forth in order to provide a thorough understanding of various exemplary embodiments of the invention. As used herein “embodiments” are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various exemplary embodiments are described herein with reference to sectional and/or exploded illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

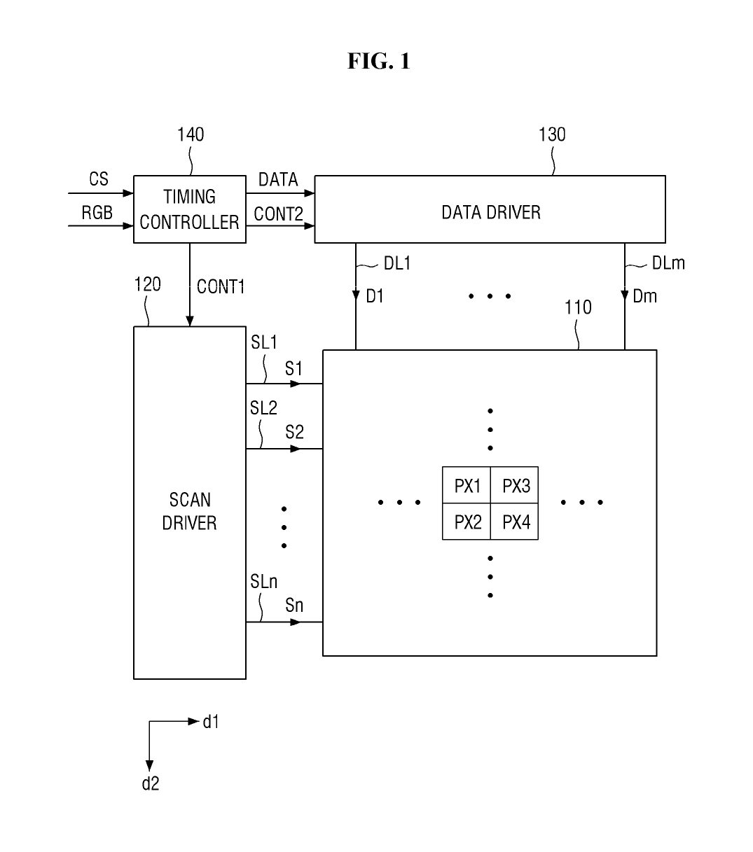

FIG. 1 is a block diagram schematically showing a liquid crystal display device according to an exemplary embodiment of the present invention.

Referring to FIG. 1, a liquid crystal display device according to an exemplary embodiment of the present invention may include a display unit 110, a scan driver 120, a data driver 130, and a timing controller 140.

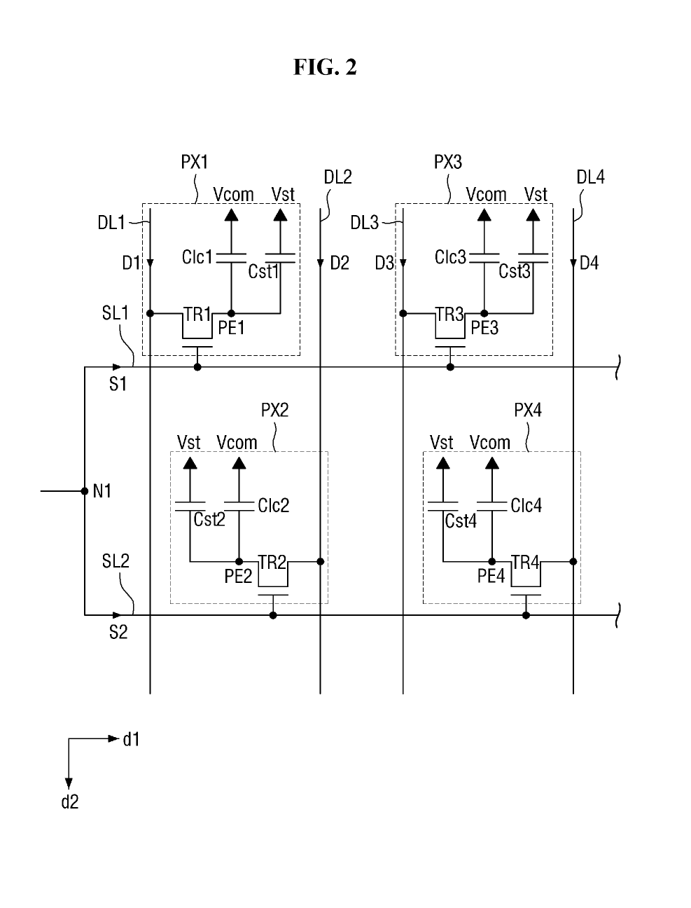

The display unit 110 is defined as an area for displaying an image. A plurality of pixel units including first to fourth pixel units PX1 to PX4 may be arranged in the display unit 110. The plurality of pixel units may be electrically connected to one of first to nth scan lines SL1 to SLn (n is a natural number of 2 or more) and one of first to mth data lines DL1 to DLm (m is a natural number of 2 or more), respectively. Here, the first to nth scan lines SL1 to SLn may extend in the first direction d1. Further, the first to mth data lines DL1 to DLm may extend in the second direction d2. The first direction d1 may intersect the second direction d2 in an exemplary embodiment. Referring to FIG. 1, the first direction d1 is exemplified as a row direction, and the second direction d2 is exemplified as a column direction. Meanwhile, two adjacent scan lines among the first to nth scan lines SL1 to SLn may be electrically connected to each other. For example, the first scan line SL1 may be electrically connected to the second scan line SL2. Details thereof will be described with reference to FIG. 2.

The scan driver 120 may generate first to nth scan signals S1 to Sn based on a first control signal CONT1 received from the timing controller 140. The scan driver 120 may provide the generated first to nth scan signals S1 to Sn to the plurality of pixel units arranged in the display unit 110 through the first to nth scan lines SL1 to SLn. The scan driver 120 may be formed through a plurality of switching elements in an exemplary embodiment, or may be an integrated circuit in another exemplary embodiment.

The data driver 130 may receive a second control signal CONT2 and image data DATA from the timing controller 140. The data driver 130 may generate first to mth data signals D1 to Dm based on the second control signal CONT2 and the image data DATA. The data driver 130 may provide the generated first to mth data signals D1 to Dm to the plurality of pixel units arranged in the display unit 110 through the first to mth data lines DL1 to DLm. In an exemplary embodiment, the data driver 130 may include a shift register, a latch, and a digital-analog converter.

The timing controller 140 may receive an image signal RGB and a control signal CS. The timing controller 140 processes the image signal RGB and the control signal in accordance with the operation conditions of the display unit 110, so as to generate the image data DATA, the first control signal CONT1, and the second control signal CONT2. In an exemplary embodiment, the timing controller 140 may generate a first control signal CONT1 and a second control signal CONT2 suitable for a 120 Hz driving method.

The image signal RGB may include a plurality of gradation data to be provided to the display unit 110. Further, in an exemplary embodiment, the control signal CS may include a horizontal synchronization signal, a vertical synchronization signal, and a main clock signal. The horizontal synchronization signal represents the time taken to display one line of the display unit 110. The vertical synchronization signal represents the time taken to display an image of one frame. The main clock signal is a signal used as a reference for generating various signals in synchronization with the scan driver 120 and the data driver 130, respectively, by the timing controller 140.

Hereinafter, the plurality of pixel units arranged in the display unit 110 will be described in more detail with reference to the first to fourth pixel units PX1 to PX4.

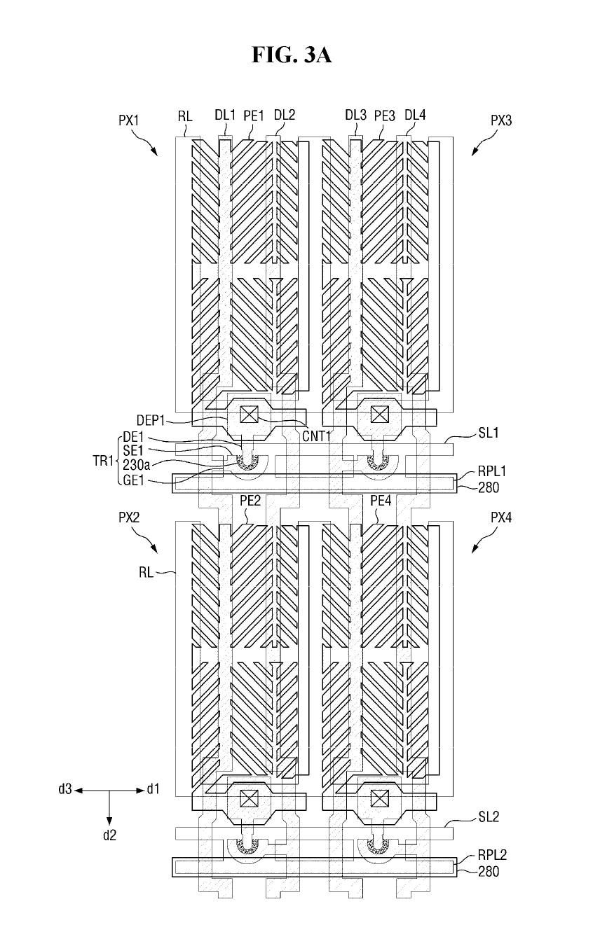

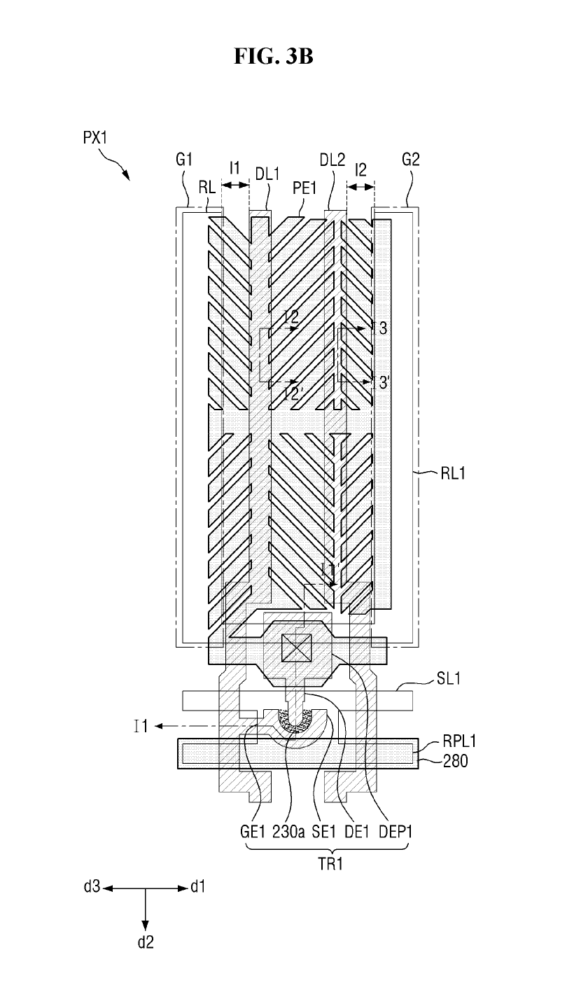

FIG. 2 is an equivalent circuit diagram of first to fourth pixel units shown in FIG. 1. FIG. 3A is a layout view showing the first to fourth pixel units shown in FIG. 1. FIG. 3B is a view more specifically showing the first pixel unit PX1 shown in FIG. 3A.

Referring to FIGS. 2, 3A, and 3B, the first pixel unit PX1 and the second pixel unit PX2 may be disposed adjacent to each other along the second direction d2. Further, the third pixel unit PX3 and the fourth pixel unit PX4 may also be disposed adjacent to each other along the second direction d2. That is, the first to fourth pixel units PX1 to PX4 may respectively receive different data signals from different data lines, that is, the first to fourth data lines DL1 to DL4. Meanwhile, the pixel units arranged in the same row may receive a scan signal from the same scan line. That is, the first pixel unit PX1 and the third pixel unit PX3 may receive the first scan signal S1 from the first scan line SL1, and the second pixel unit PX2 and the fourth pixel unit PX4 may receive the second scan signal S2 from the second scan line SL2.

Here, the first scan line SL1 and the second scan line SL2 are electrically connected to each other through the first node N1. That is, the first scan signal S1 provided from the first scan line SL1 and the second scan signal S2 provided from the second scan line SL2 may be the same signal. The position of the first node N1 is not particularly limited, and, in an exemplary embodiment, the first node N1 may be disposed in a non-display area where an image is not displayed. Meanwhile, the first scan line SL1 and the second scan line SL2 are not necessarily electrically connected to each other only at the first node N1. That is, there may be a plurality of nodes at which the first scan line SL1 and the second scan line SL2 are connected to each other.

Each of the first to fourth pixel units PX1 to PX4 may include a switching element, a pixel electrode, a liquid crystal capacitor, and a storage capacitor. This configuration will be described in more detail with reference to the first pixel unit PX1.

The first pixel unit PX1 may include a first switching element TR1, a first pixel electrode PE1, a first liquid crystal capacitor Clc1, and a first storage capacitor Cst1.

In an exemplary embodiment, the first switching element TR1 may be a thin film transistor having an input electrode, an output electrode, and a control electrode. Hereinafter, the input electrode is referred to as a source electrode, the output electrode is referred to as a drain electrode, and the control electrode is referred to as a gate electrode.

The first switching element TR1 may include a first gate electrode GE1 electrically connected with the first scan line SL1, a first source electrode SE1 electrically connected with the first data line DL1, and a first drain electrode DE1 electrically connected with the first pixel electrode PE1. Here, the first drain electrode DE1 of the first switching element TR1 may be electrically connected with the first pixel electrode PE1 through a first contact hole CNT1. The first switching element TR1 may perform a switching operation based on the first scan signal S1 received from the first scan line SL1 to provide the first data signal D1 received from the first data line DL1 to the first pixel electrode PE1.

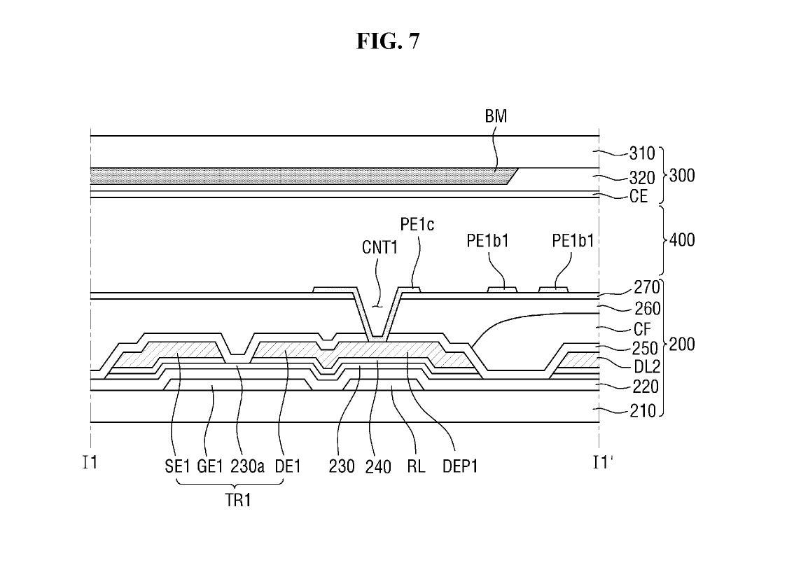

The first liquid crystal capacitor Clc1 is formed between the first pixel electrode PE1 and a common electrode (refer to FIG. 7) provided with a common voltage Vcom. The first storage capacitor Cst1 is formed between the first pixel electrode PE1 and a storage line RL provided with a storage voltage Vcst. The shape of the first pixel electrode PE1 and the relationship between the first pixel electrode PE1 and other components will be described later.

Hereinafter, the driving of the liquid crystal display device according to an exemplary embodiment of the present invention will be described with reference to the first pixel unit PX1 and the second pixel unit PX2.

The first switching element TR1 performs a switching operation based on the first scan signal S1. Further, the second switching element TR2 performs a switching operation based on the second scan signal S2. However, as described above, the first scan line SL1 and the second scan line SL2 are electrically connected to each other. That is, the first scan signal S1 and the second scan signal S2 are substantially the same signal.

Accordingly, the first switching element TR1 and the second switching element TR2 perform the same switching operation. However, since the first switching element TR1 is electrically connected to the first data line DL1 while the second switching element TR2 is electrically connected to the second data line DL2, different data signals from each other may be provided to the first pixel electrode PE1 and the second pixel electrode PE2. That is, the first pixel electrode PE1 and the second pixel electrode PE2 may receive different data signals from each other at the same time. Accordingly, the liquid crystal display device according to an exemplary embodiment of the present invention can be applied to high-resolution products requiring high-frequency driving.

Next, the arrangement relationship of components of the liquid crystal display device according to an exemplary embodiment of the present invention will be described with reference to FIGS. 3A to 8. For convenience of explanation, a description thereof will be made with reference to the first pixel unit PX1.

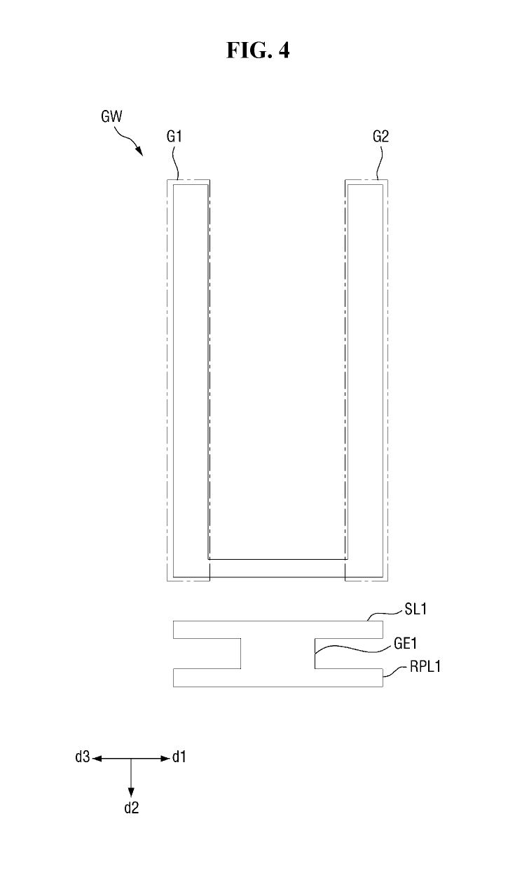

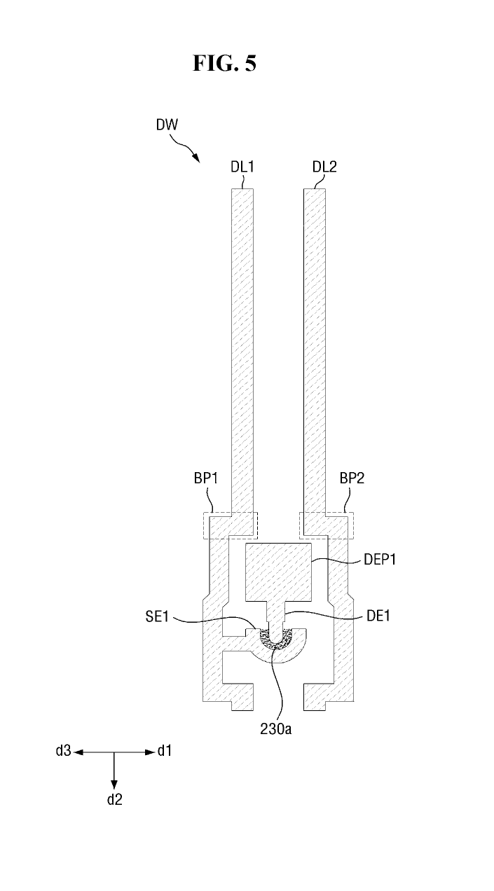

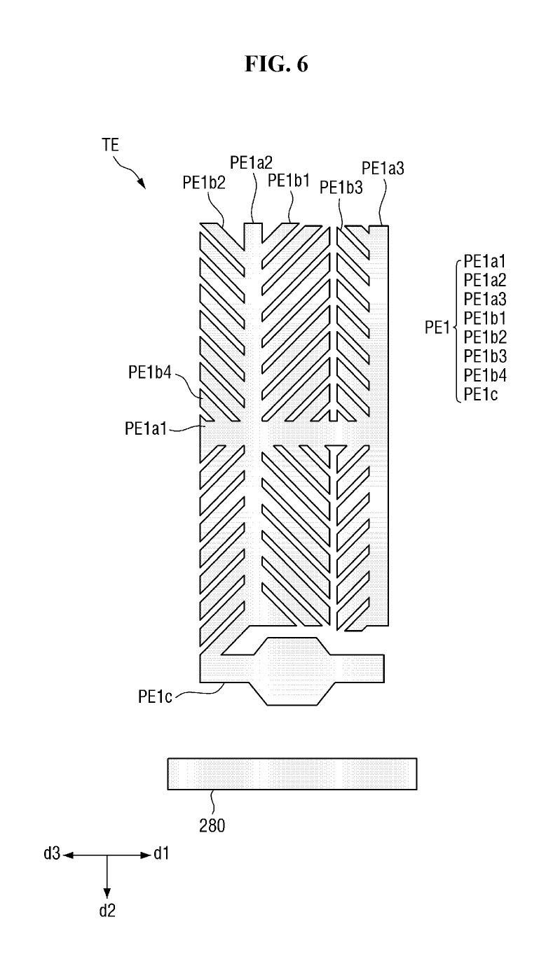

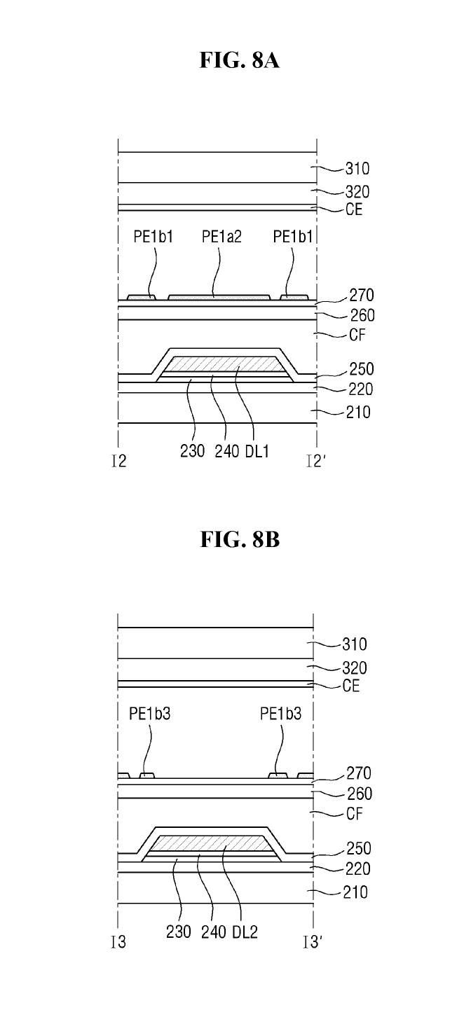

FIG. 4 is a view showing a gate conductor included in the first pixel unit shown in FIG. 3B. FIG. 5 is a view showing a data conductor included in the first pixel unit shown in FIG. 3B. FIG. 6 is a view showing a transparent conductor included in the first pixel unit shown in FIG. 3B. FIG. 7 is a cross-sectional view taken along the line I1-I1′ shown in FIG. 3B. FIG. 8A is a cross-sectional view taken along the line I2-I2′ shown in FIG. 3B, and FIG. 8B is a cross-sectional view taken along the line I3-I3′ shown in FIG. 3B. Hereinafter, the structure of the first pixel unit PX1 will be described.

A first display panel 200 is disposed to face a second display panel 300. A liquid crystal layer 400 is disposed between the first display panel 200 and the second display panel 300. The liquid crystal layer 400 may include a plurality of liquid crystal molecules 410. In an exemplary embodiment, the first display panel 200 may be attached to the second display panel 300 by sealing.

The first display panel 200 will be described.

In an exemplary embodiment, a first substrate 210 may be a transparent insulation substrate. Here, the transparent insulation substrate may include a glass material, a quartz material, or a light-transmitting plastic material. In another exemplary embodiment, the first substrate 210 may be a flexible substrate, or may have a laminate structure of a plurality of films or the like.

A gate conductor GW may be disposed on the first substrate 210. The gate conductor GW may include a plurality of scan lines including a first scan line SL1, a plurality of gate electrodes including a first gate electrode GE1, and a storage line RL. The gate conductor GW may further include a plurality of repair lines including a first repair line RPL1.

The first scan line SL1 extends in the first direction d1, and is directly connected to the first gate electrode GE1. The first repair line RPL1 extends along the first direction d1, and may be spaced apart from the first scan line SL1. The first repair line RPL1 may be electrically connected to the first scan line SL1. In an exemplary embodiment, the first repair line RPL1 is directly connected to the first gate electrode GE1 and a gate electrode disposed in the same row as the first gate electrode GE1, and thus, first repair line RPL1 may be electrically connected to the first scan line SL1. The first repair line RPL1 may also receive the same scan signal as the first scan line SL1. Accordingly, even when the first scan line SL1 is disconnected, the first switching element TR1 can normally perform a switching operation. Meanwhile, the first repair line RPL1 may be omitted. Further, the positions of the first repair line RPL1 and the first scan line SL1 may be mutually changed.

The storage line RL may be disposed on the same layer as the plurality of scan lines including the first scan line SL1. In an exemplary embodiment, the storage line RL may surround the first pixel electrode PE1. However, the shape of the storage line RL is not limited to those shown in FIGS. 3 and 4.

The storage line RL may overlap at least a part of the first pixel electrode PE1. As used herein, the term “overlap” means that two components overlap each other in the vertical direction with respect to the first substrate 210 unless otherwise defined. The first pixel electrode PE1 and the storage line RL overlap each other, thereby forming the above-described first storage capacitor Cst1.

The gate conductor GW may be formed of a single film containing any one conductive metal selected from aluminum (Al), copper (Cu), molybdenum (Mo), chromium (Cr), titanium (Ti), tungsten (W), molybdenum tungsten (MoW), molybdenum titanium (MoTi), and copper/molybdenum titanium (Cu/MoTi), a double film containing two conductive metals, or a triple film containing three conductive metals. The plurality of scan lines including the first scan line SL1, the plurality of gate electrodes including the first gate electrode GE1, the storage line RL, and the plurality of repair lines including the first repair line RPL1, which are included in the gate conductor GW, may be simultaneously formed through the same mask process.

A gate insulation layer 220 may be disposed on the gate conductor GW. In an exemplary embodiment, the gate insulation layer 220 may contain silicon nitride, silicon oxide, or the like. The gate insulation layer 220 may have a multi-layer structure including at least two insulation layers having different physical properties.

The data conductor DW may be disposed over the gate insulation layer 220. The data conductor DW may include a semiconductor layer 230 having a plurality of data lines including a first data line DL1, a plurality of source electrodes including the first source electrode SE1, a plurality of drain electrodes including a first drain electrode DE1, and a first semiconductor pattern 230a.

The semiconductor layer 230 may be disposed on the gate insulation layer 220. In an exemplary embodiment, the semiconductor layer 230 may be formed of, for example, amorphous silicon, polycrystalline silicon, or the like. In another exemplary embodiment, the semiconductor layer 230 may contain an oxide semiconductor. When the semiconductor layer 230 contains an oxide semiconductor, the semiconductor layer 230 may be formed of any one selected from the group consisting of IGZO(In—Ga—Zinc-Oxide), ZnO, ZnO₂, CdO, SrO, SrO₂, CaO, CaO₂, MgO, MgO₂, InO, In₂O₂, GaO, Ga₂O, Ga₂O₃, SnO, SnO₂, GeO, GeO₂, PbO, Pb₂O₃, Pb₃O₄, TiO, TiO₂, Ti₂O₃, and Ti₃O₅.

The first semiconductor pattern 230a of the semiconductor layer 230 may form a channel region of the first switching element TR1.

The data conductor DW may further include an ohmic contact layer 240. The ohmic contact layer 240 may be disposed on the semiconductor layer 230. The ohmic contact layer 240 may be made of a material such as n+ hydrogenated amorphous silicon doped with n-type impurity, such as phosphorus at a high concentration, or may be made of a silicide. However, the ohmic contact layer 240 may be omitted if the semiconductor layer 230 is formed of an oxide semiconductor. Hereinafter, a case where the data conductor DW includes the ohmic contact layer 240 will be described.

The first data line DL1, the first source electrode SE1, and the first drain electrode DE1 may be disposed on the gate insulation layer 220 and the ohmic contact layer 240. The first source electrode SE1 may be branched from the first data line DL1, and at least a part thereof may overlap the first gate electrode GE1. The first drain electrode DE1 may overlap the first gate electrode GE1, and may be spaced apart from the first source electrode SE1 by a predetermined distance. Meanwhile, the first drain electrode DE1 may further include a first drain electrode extension portion DEP1. The first drain electrode extension portion DEP1 may overlap the storage line RL and the first contact hole CNT1.

Although it is shown in FIGS. 3B and 5 that the first source electrode SE1 has a U-shape and the first drain electrode DE1 is surrounded by the first source electrode SE1, the inventive concepts are not limited thereto. The first source electrode SE1, the first drain electrode DE1, the drain electrode extension portion DEP1, the first semiconductor pattern 230a, and the first gate electrode GE1 may form the aforementioned first switching element TR1.

The first data line DL1 may include a first bent region BP1 to prevent a short circuit with the first drain electrode extension portion DEP1. Further, the second data line DL2 may include a second bent region BP2 to prevent a short circuit with the first drain electrode extension portion DEP1. Here, the first and second bent regions BP1 and BP2 may be disposed at positions overlapping the first pixel electrode PE1 to be described later. However, the inventive concepts are not limited thereto. The bent regions may be omitted, and the positions of the bent regions are not limited to those shown in the drawings.

The data conductor DW may be formed of a single film containing any one conductive metal selected from aluminum (Al), copper (Cu), molybdenum (Mo), chromium (Cr), titanium (Ti), tungsten (W), molybdenum tungsten (MoW), molybdenum titanium (MoTi), and copper/molybdenum titanium (Cu/MoTi), a double film containing two conductive metals, or a triple film containing three conductive metals. However, the inventive concepts are not limited thereto, and the data conductor DW may be made of various metals or conductors. The data conductor DW may be simultaneously formed through the same mask process.

A first passivation film 250 may be disposed on the data conductor DW. The first passivation film 250 includes an opening exposing at least a part of the first drain electrode extension portion DEP1. In an exemplary embodiment, the first passivation film 250 may be formed of an inorganic insulating material, such as silicon nitride or silicon oxide. The first passivation film 250 can prevent the pigment of an organic insulation film 260, which will be described later, from flowing into the first semiconductor pattern 230a.

A color filter CF may be disposed on the first passivation film 250. Light having passed through the color filter CF may express one of primary colors such as red, green, and blue. However, the color of the light having passed through the color filter CF is not limited to the primary colors, and any one of cyan, magenta, yellow, and white colors may be expressed. The color filter CF may be formed of a material that expresses different colors for each adjacent pixel unit. Although it is shown in FIG. 7 that the color filter CT is disposed over the first display panel 200, the color filter CF may be disposed over the second display panel 300, unlike that shown FIG. 7.

An organic insulation film 260 may be disposed on the first passivation film 250 and the color filter CF. The organic insulation film 260 overlaps the opening of the first passivation film, and includes an opening exposing at least a part of the first drain electrode extension portion DEP1. The organic insulation film 260 may contain an organic material having excellent planarization characteristics and photosensitivity. The organic insulation film 260 may be omitted.

A second passivation film 270 may be disposed on the organic insulation film 260. In an exemplary embodiment, the second passivation film 270 may be formed of an inorganic insulating material such as silicon nitride or silicon oxide. The second passivation film 270 may be omitted.

The opening of the first passivation film 250, the opening of the organic insulation film 260, and the opening of the second passivation film 270 may form the first contact hole CNT1.

A transparent conductor TE may be disposed on the second passivation film 270. The transparent conductor TE may contain a transparent conductive material. Here, the transparent conductive material may include polycrystalline, monocrystalline or amorphous indium tin oxide (ITO). The transparent conductor TE may include a plurality of pixel electrode including the first pixel electrode PE1 and a shielding electrode 280. In an exemplary embodiment, the first pixel electrode PE1 and the shielding electrode 280 may be formed simultaneously by the same mask process. The first pixel electrode PE1 and the shielding electrode 280 are disposed on the same layer, but are physically and electrically insulated from each other.

The shielding electrode 280 may extend substantially along the first direction d1. In an exemplary embodiment, the shielding electrode 280 may overlap a plurality of repair lines including the first repair line RPL1. In an exemplary embodiment, the voltage provided to the shielding electrode 280 may be equal in voltage level to the common voltage Vcom (refer to FIG. 2) provided to the common electrode CE. In another exemplary embodiment, the common voltage Vcom may be directly provided to the shielding electrode 280.

The first pixel electrode PE1 may be in direct contact with the first drain electrode extension portion DEP1 exposed through the first contact hole CNT1. Further, the first pixel electrode PE1 overlaps the common electrode CE. Accordingly, the first liquid crystal capacitor Clc1 (refer to FIG. 2) may be formed between the first pixel electrode PE1 and the common electrode CE, which overlap each other.

Hereinafter, the shape of the first pixel electrode PE1 will be described in more detail.

The first pixel electrode PE1 includes a first stem PE1a1 extending in the first direction d1, a second stem PE1a2 extending in the second direction d2, and a third stem PE1a3 extending in the second direction d2 and spaced apart from the second stem PE1a2. That is, the first stem PE1a1 is a horizontal stem extending in a horizontal direction with reference to FIG. 6, and the second stem PE1a2 and the third stem PE1a3 are vertical stems extending in the vertical direction with reference to FIG. 6. The first stem PE1a1, the second stem PE1a2, and the third stem PE1a3 are physically and electrically connected to each other. In an exemplary embodiment, the second stem PE1a2 and the third stem PE1a3 may be electrically connected to each other through the first stem PE1a1. Meanwhile, in an exemplary embodiment, one side and the other side of the first stem PE1a1 may at least partially overlap a first region G1 and a second region G2 of the storage line RL. The second stem PE1a2 may overlap the first data line DL1. Further, the third stem PE1a3 may at least partially overlap the second region G2 of the storage line RL.

The first pixel electrode PE1 may include a plurality of first branches PE1b1, a plurality of second branches PE1b2, a plurality of third branches PE1b3, and a plurality of fourth branches PE1b4.

The plurality of first branches PE1b1 and the plurality of second branches PE1b2 are defined as branches extending from the second stem PE1a2. More specifically, the plurality of first branches PE1b1 are defined as branches disposed at one side of the second stem PE1a2 and extending in a direction (substantially, the first direction d1) in which the plurality of first branches PE1b1 are arranged.

The plurality of second branches PE1b2 are defined as branches disposed at the other side of the second stem PE1a2 and extending in a direction (substantially, the third direction d3) in which the first region G1 of storage line RL is disposed. That is, the extension direction of the plurality of first branches PE1b1 may be symmetrical with the extension direction of the plurality of second branches PE1b2 with respect to the plurality of second stems PE1a2. Here, at least some of the plurality of first branches PE1b1 may at least partially overlap the second data line DL2. Further, at least some of the plurality of second branches PE1b2 may overlap the first region G1 of the storage line RL.

The plurality of third branches PE1b3 are defined as branches extending from the third stem PE1a3. More specifically, the plurality of third branches PE1b3 are defined as branches extending in a direction from the third stem PE1a3 toward the second stem PE1a2. The plurality of third branches PE1b3 may also be defined as branches extending from the third stem PE1a3 to face the plurality of first branches PE1b1. Here, at least some of the plurality of third branches PE1b3 may be at least partially overlap the second data line DL2. That is, the second data line DL2 may overlap at least some of the plurality of first branches PE1b1 and at least some of the plurality of third branches PE1b3, respectively. Accordingly, the second data line DL2 may be disposed in an empty space between the plurality of first branches PE1b1 and the plurality of third branches PE1b3.

As described above, the first data line DL1 may overlap the second stem PE1a2 of the first pixel electrode PE1. The second data line DL2 may overlap the ends of the plurality of first branches PE1b1 and the plurality of third branches PE1b3, and thus, may be disposed in an empty space between the plurality of first branches PE1b1 and the plurality of third branches PE1b3. Thus, it is possible to minimize the area of a dark portion due to the first data line DL1 and the second data line DL2 in the opening region (the region through which light is transmitted) of the first pixel unit PX1. Further, as the area of the dark portion is minimized, the aperture ratio can be improved.

Meanwhile, a region of the first data line DL1 overlapping the first pixel electrode PE1 and a region of the second data line DL2 overlapping the first pixel electrode PE1 may be disposed between the first region G1 and second region G2 of the storage line RL. That is, the distance 11 between the first data line DL1 and the first region G1 of the storage line RL may be substantially equal to the distance 12 between the second data line DL2 and the second region G2 of the storage line RL.

The plurality of fourth branches PE1b4 are defined as branches extending from the first stem PE1a1. The extension direction of the plurality of fourth branches PE1b4 may be different depending on the arrangement position, but may be substantially the same as the extension direction of the adjacent branch. Meanwhile, the plurality of fourth branches PE1b4 may include at least one of a branch overlapping the first data line DL1 and a branch overlapping the second data line DL2.

The first pixel electrode PE1 may further include a first connection portion PE1c. The first connection portion PE1c is defined as a region extending from the plurality of second branches PE1b2 and overlapping the first contact hole CNT1. Therefore, the first connection portion PE1c of the first pixel electrode PE1 may be directly connected to the exposed first drain electrode extension portion DEP1. In an exemplary embodiment, the first connection portion PE1c of the first pixel electrode PE1 may overlap at least one of the first data line DL1 and the second data line DL2. Meanwhile, the first connection portion PE1c may be connected to at least one of the plurality of first branches PE1b1, the second stem PE1a2, and the third stem PE1a3, in addition to the plurality of second branches PE1b2.

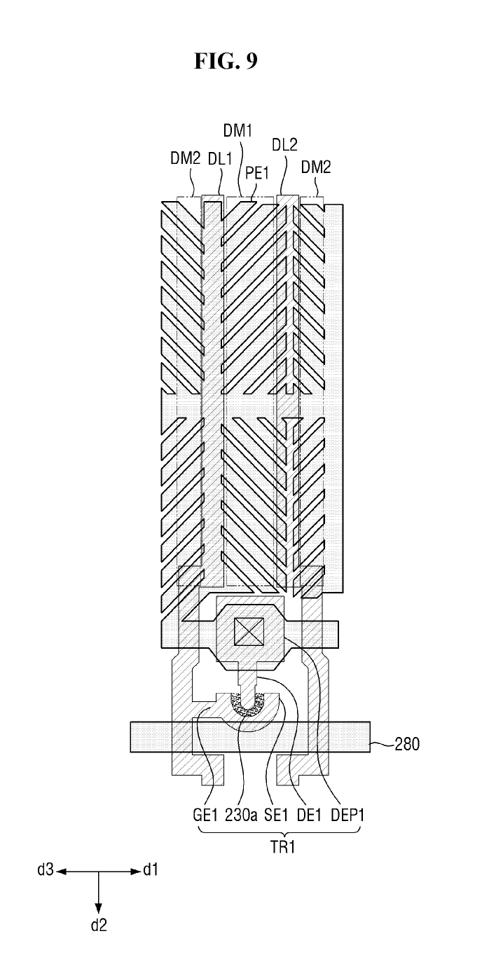

Hereinafter, domain regions of the first pixel electrode PE1 will be described in more detail with reference to FIG. 9.

FIG. 9 is a view showing both the data conductor and transparent conductor of the first pixel unit shown in FIG. 3B.

Referring to FIG. 9, the first pixel electrode PE1 may include first to third domain regions DM1 to DM3.

The first domain region DM1 is disposed at one side of the first data line DL1. That is, the first domain region DM1 is disposed between the first data line DL1 and the second data line DL2. The second domain region DM2 is disposed at the other side of the first data line DL1 opposite to the one side thereof. The third domain region DM3 is disposed at one side of the second data line DL2.

When an electric field is formed, a plurality of liquid crystal molecules arranged in the first domain region DM1 may be aligned in the third direction d3, which is substantially opposite to the first direction d1. In contrast, when an electric field is formed, a plurality of liquid crystal molecules arranged in the second domain region DM2 and the third domain region DM3 may be aligned in the first direction d1.

The area of the first domain region DM1 may be substantially equal to the sum of the area of the second domain region DM2 and the area of the third domain region DM3. That is, the area of the first domain region DM1, in which a plurality of liquid crystal molecules having a liquid crystal alignment in the third direction d3 are arranged, may be substantially equal to the sum of the area of the second domain region DM2 and the area of the third domain region DM3, in each which a plurality of liquid crystal molecules having a liquid crystal alignment in the first direction d1 are arranged.

Referring again to FIGS. 3B to 8, a first alignment film (not shown) may be disposed on the transparent conductor TE. The first alignment film can induce the initial alignment of the plurality of liquid crystal molecules in the liquid crystal layer 400. In an exemplary embodiment, the first alignment film may include an organic polymer material having an imide group in the repeating unit of the main chain thereof.

Next, the second display panel 300 will be described.

A second substrate 310 is disposed to face the first substrate 210. The second substrate 310 may be formed of transparent glass, plastic, or the like, and, in an exemplary embodiment, may be formed of the same material as the first substrate 310.

A black matrix BM may be disposed on the second substrate 310. The black matrix BM may overlap a non-pixel area, which is the remaining area excluding the pixel area for displaying an image. The black matrix BM can prevent light from being transmitted to the non-pixel area. The material of the black matrix BM is not particularly limited as long as it has the ability to block light. In an exemplary embodiment, the black matrix BM may be formed of a photosensitive composition, an organic material, or a metallic material. In an exemplary embodiment, the photosensitive composition may include a binder resin, a polymerizable monomer, a polymerizable oligomer, a pigment, and a dispersant. The metallic material may include chromium.

A planarization layer 320 may be disposed on the black matrix BM. The planarization layer 320 may provide planarity to the common electrode CE. The material of the planarization layer 320 is not particularly limited, and, in an exemplary embodiment, may include an organic material or an inorganic material.

The common electrode CE may be disposed on the planarization layer 320. At least a part of the common electrode CE may overlap the first pixel electrode PE1. In an exemplary embodiment, the common electrode CE may be formed in the shape of a plate. However, the inventive concepts are not limited thereto, and the common electrode CE may have a plurality of slits. In an exemplary embodiment, the common electrode CE may be made of a transparent conductive material such as ITO or IZO, or may be made of a reflective metal such as aluminum, silver, chromium, or an alloy thereof.

Although not shown in the drawings, a second alignment film may be disposed on the common electrode CE. The second alignment film can induce the initial alignment of the plurality of liquid crystal molecules in the liquid crystal layer 400. In an exemplary embodiment, the second alignment film may be made of the same material as the first alignment film.

Subsequently, the liquid crystal layer 400 will be described.

The liquid crystal layer 400 includes a plurality of liquid crystal molecules. In an exemplary embodiment, the plurality of liquid crystal molecules 410 may be vertically aligned in an initial alignment state with negative dielectric anisotropy. The plurality of liquid crystal molecules may have a predetermined pretilt angle in the initial alignment state. The initial alignment of the plurality of liquid crystal molecules may be induced by the aforementioned first and second alignment films. When an electric field is formed between the first display panel 200 and the second display panel 300, the plurality of liquid crystal molecules can change the polarization state of light transmitted to the liquid crystal layer 400 by tilting or rotating in a specific direction.

That is, in the liquid crystal display device according to an exemplary embodiment of the present invention, for high-resolution driving, two adjacent scan lines may be electrically connected to each other to simultaneously provide data signals to the pixel electrodes connected to the two scan lines. In addition, data lines overlap the spaces between the stems and branches of the pixel unit, so that the area of a dark portion by the data lines can be reduced, so as to improve an aperture ratio.

Next, a liquid crystal display device according to another exemplary embodiment of the present invention will be described. However, a description overlapping those having been described with reference to FIGS. 1 to 9 will be omitted. Further, the same reference numerals are used for the same components as those having been described with reference to FIGS. 1 to 9.

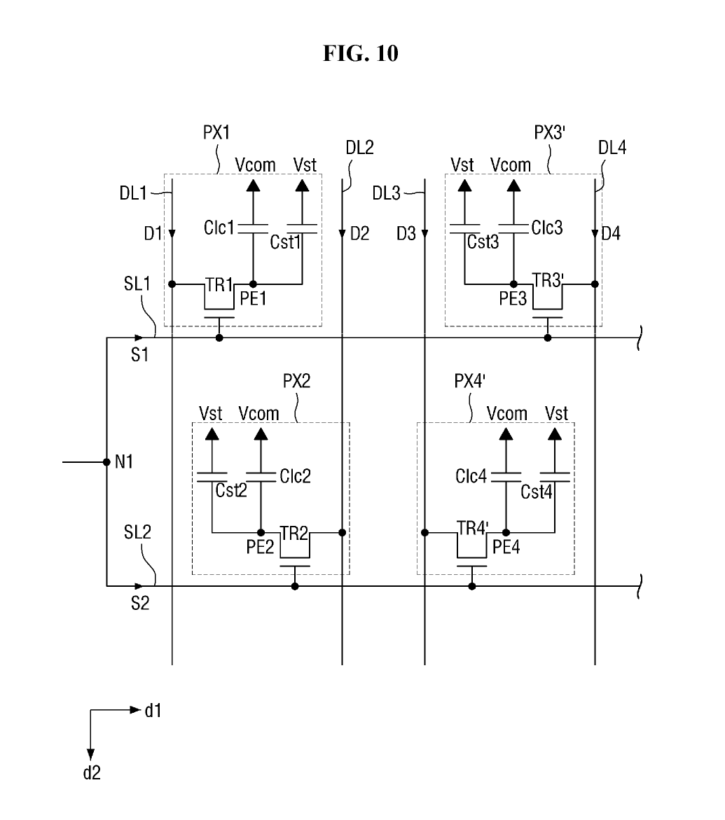

FIG. 10 is an equivalent circuit diagram of a liquid crystal display device according to another exemplary embodiment of the present invention.

The liquid crystal display device shown in FIG. 10 differs from the liquid crystal display device shown in FIG. 2 in that a third switching element TR3′ included in a third pixel unit PX3′ is electrically connected to the fourth data line DL4, and a fourth switching element TR4′included in a fourth pixel unit PX4′ is connected to the third data line DL3.

That is, the liquid crystal display device shown in FIG. 10 differs from the liquid crystal display device shown in FIG. 2 in that pixel units arranged in the same column are arranged to be staggered from each other, but the stagger direction of the pixel units in the liquid crystal display device of FIG. 10 is different from that in the liquid crystal display device of FIG. 2.

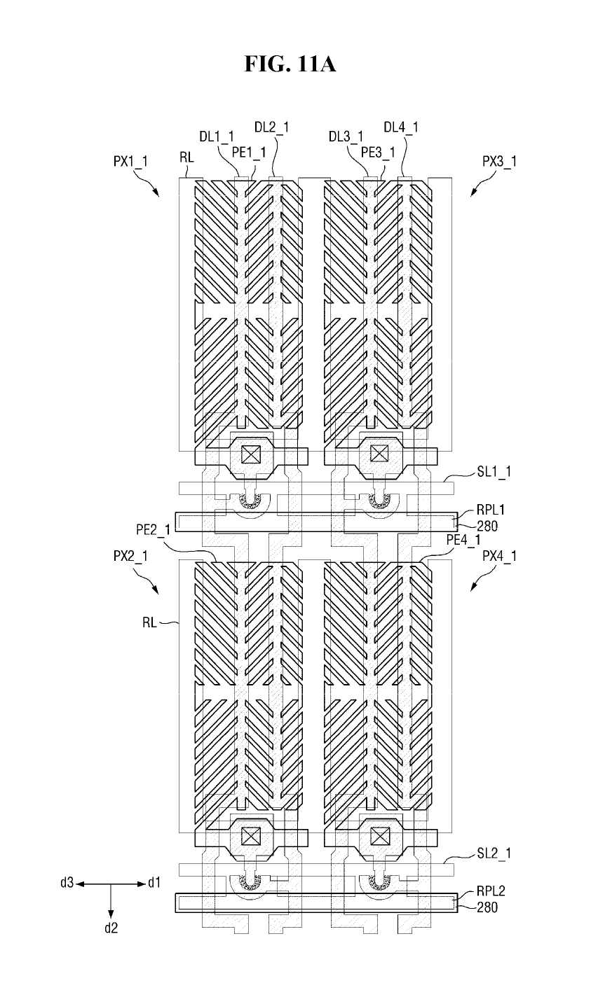

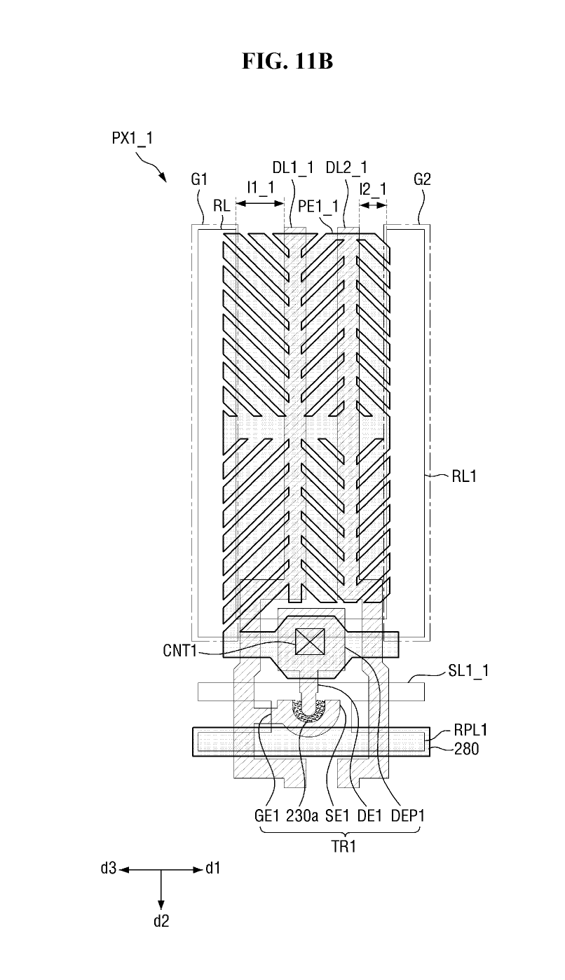

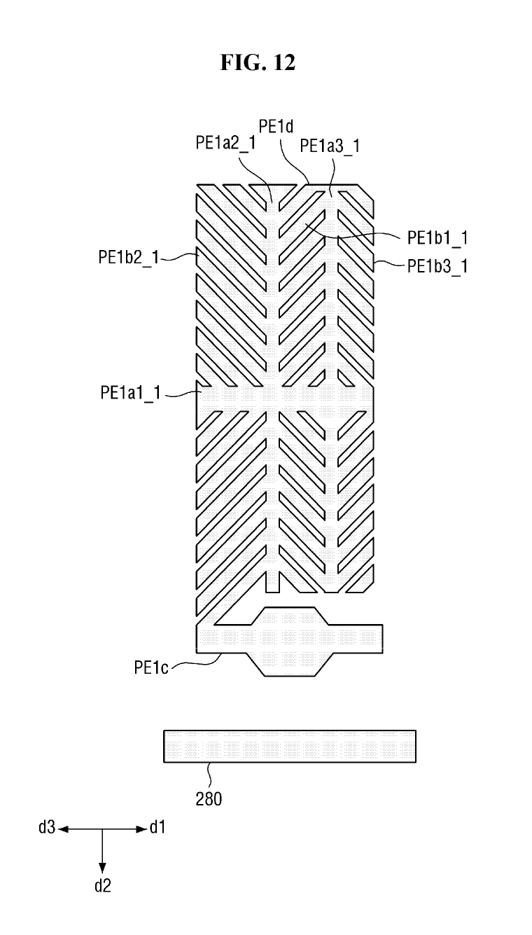

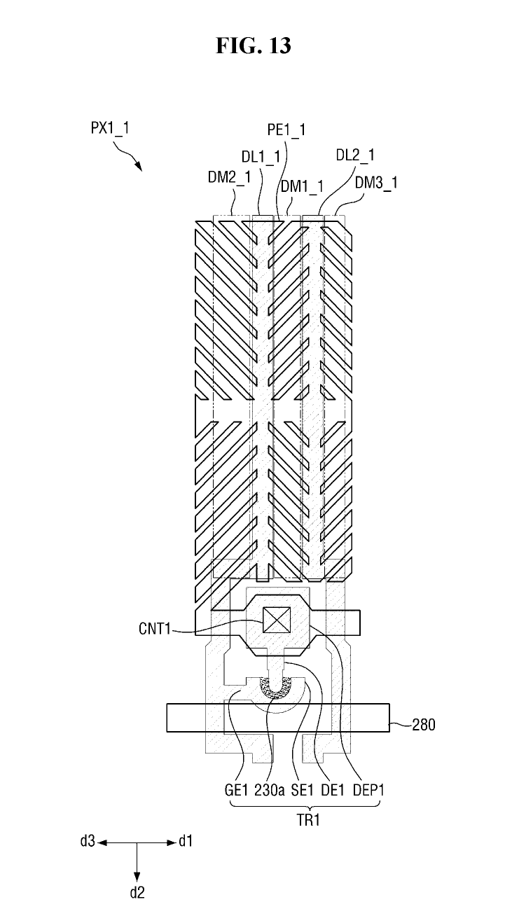

FIGS. 11A and 11B are layout views showing pixel units included in a liquid crystal display device according to still another exemplary embodiment of the present invention. FIG. 12 is a view showing a transparent conductor included in the pixel unit shown in FIGS. 11A and 11B. FIG. 13 is a view showing both a data conductor and a transparent conductor included in the pixel unit shown in FIG. 11.

The liquid crystal display device shown in FIGS. 11A to 13 differs from the liquid crystal display device shown in FIGS. 1 to 9 in that the shape of a pixel electrode and the shape of a data line are different. Hereinafter, the liquid crystal display according to another exemplary embodiment of the present invention will be described with reference to the first pixel unit PX1_1 among first to fourth pixel units PX1_1 to PX4_1.

A first pixel electrode PE1_1 includes a first stem PE1a1_1 extending in the first direction d1, a second stem PE1a2_1 extending in the second direction d2, and a third stem PE1a3_1 extending in the second direction d2 and spaced apart from the second stem PE1a2_1. That is, the first stem PE1a1_1 is a horizontal stem extending in a horizontal direction with reference to FIGS. 11A and 11B, and the second stem PE1a2_1 and the third stem PE1a3_1 are vertical stems extending in the vertical direction with reference to FIGS. 11A and 11B.

The first stem PE1a1_1, the second stem PE1a2_1, and the third stem PE1a3_1 are physically and electrically connected to each other. In an exemplary embodiment, the second stem PE1a2_1 and the third stem PE1a3_1 may be electrically connected to each other through the first stem PE1a1_1.

Meanwhile, in an exemplary embodiment, one side and the other side of the first stem PE1a1_1 may at least partially overlap a first region G1 and a second region G2 of the storage line RL. The second stem PE1a2_1 may overlap a first data line DL1_1. Further, the third stem PE1a3_1 may overlap a second data line DL2_1. That is, in the liquid crystal display device shown in FIG. 10, the third stem PE1a3_1 may also overlap the second data line DL2_1. Accordingly, the first data line DL1_1 and the second data line DL2_1 may overlap the second stem PE1a2_1 and the third stem PE1a3_1, respectively.

Meanwhile, the third stem PE1a3_1 does not overlap the second region G2 of the storage line RL. Further, the distance 11_1 between the second stem PE1a2_1 and the first region G1 of the storage line RL may be longer than the distance 12_1 between the third stem PE1a3_1 and the second region G2 of the storage line RL.

The first pixel electrode PE1_1 may further include a plurality of first branches PE1b1_1, a plurality of second branches PE1b2_1, a plurality of third branches PE1b3_1, and a plurality of fourth branches PE1b4_1.

The plurality of first branches PE1b1_1 and the plurality of second branches PE1b2_1 are defined as branches extending from the second stem PE1a2_1. More specifically, the plurality of first branches PE1b1_1 are defined as branches disposed at one side of the second stem PE1a2_1 and extending in a direction (substantially, the first direction d1) in which the plurality of third branches PE1b3_1 are arranged.

The plurality of second branches PE1b2_1 are defined as branches disposed at the other side of the second stem PE1a2_1 and extending in a direction (substantially, the third direction d3) in which the first region G1 of storage line RL is disposed. Here, at least some of the plurality of first branches PE1b1_1 may be at least partially overlap the second data line DL2_1. Further, at least some of the plurality of first branches PE1b1_1 may overlap the third stem PE1a3_1.

The plurality of third branches PE1b3_1 are defined as branches extending from the third stem PE1a3. More specifically, the plurality of third branches PE1b3_1 are defined as branches extending in a direction from the third stem PE1a3_1 toward the second region G2 of the storage line RL. At least some of the plurality of third branches PE1b3_1 may overlap the second region G2 of the storage line RL.

The second stem PE1a2_1 and the third stem PE1a3_1 may be electrically connected to each other through a separate second connection portion PE1d and the plurality of first branches PE1b1_1. Meanwhile, the position and shape of the second connection portion PE1d are not limited to those shown in FIGS. 11 and 12. The second connection portion PE1d may be omitted, and the second connection portion PE1d may be directly connected to each of the second stem PE1a2_1 and the third stem PE1a3_1.

In an exemplary embodiment, the first pixel electrode PE1_1 may include first to third domain regions DM1_1 to DM3_1.

The first domain region DM1_1 is disposed at one side of the first data line DL1_1. That is, the first domain region DM1_1 is disposed between the first data line DL1_1 and the second data line DL2_1. The second domain region DM2_1 is disposed at the other side of the first data line DL1_1 opposite to the one side thereof. The third domain region DM3_1 is disposed at one side of the second data line DL2_1.

When an electric field is formed, a plurality of liquid crystal molecules arranged in the first domain region DM1_1 and the third domain region DM3_1 may be aligned in the third direction d3, which is substantially opposite to the first direction d1. In contrast, when an electric field is formed, a plurality of liquid crystal molecules arranged in the second domain region DM2_1 may be aligned in the first direction d1. The area of the second domain region DM2_1 may be substantially equal to the sum of the area of the first domain region DM1_1 and the area of the third domain region DM3_1.

Next, a liquid crystal display device according to still another exemplary embodiment of the present invention will be described. However, a description overlapping those having been described with reference to FIGS. 1 to 9 will be omitted.

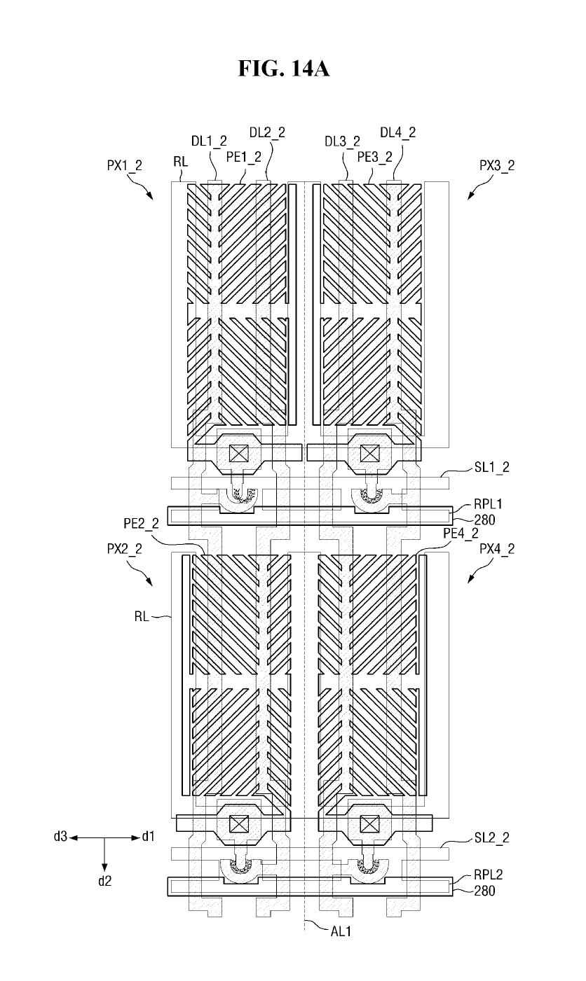

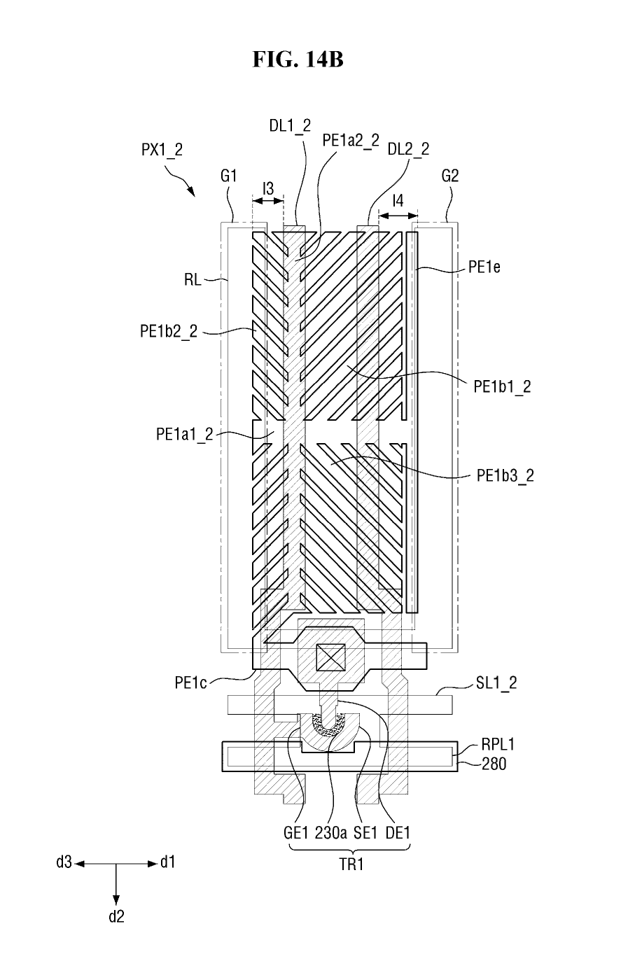

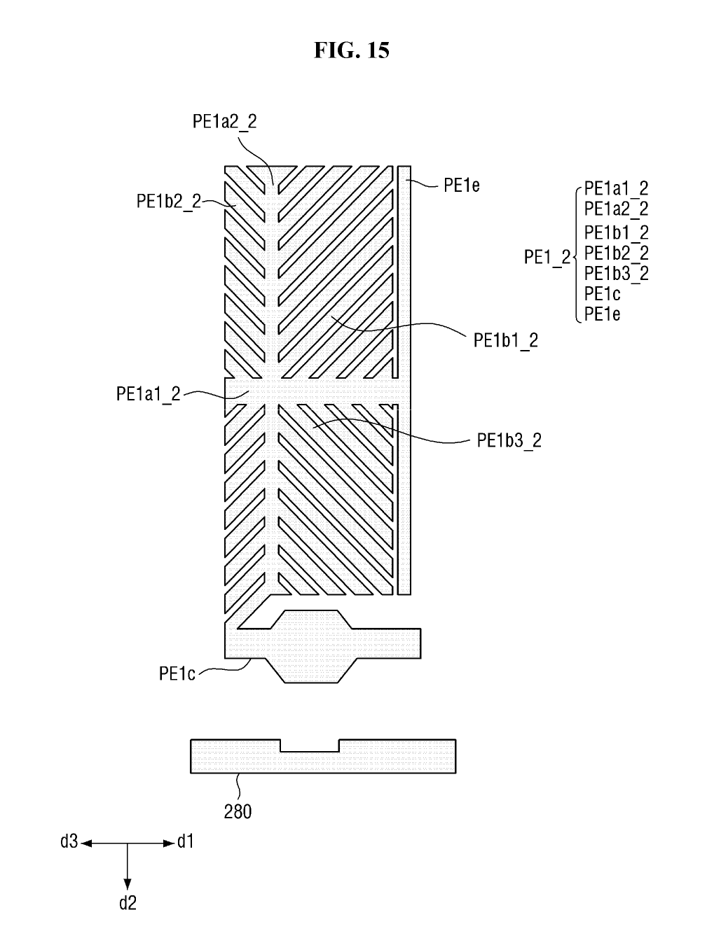

FIG. 14A is a layout view showing first to fourth pixel units included in the liquid crystal display device according to still another exemplary embodiment of the present invention. FIG. 14B is a view more specifically showing the first pixel unit shown in FIG. 14A. FIG. 15 is a view showing a transparent conductor included in the first pixel unit shown in FIG. 14B.

The liquid crystal display device shown in FIGS. 11A to 13 differs from the liquid crystal display device shown in FIGS. 1 to 9 in that the shape of a pixel electrode and the shape of a data line are different. Hereinafter, the liquid crystal display according to another exemplary embodiment of the present invention will be described with reference to the first pixel unit PX1_1 among first to fourth pixel units PX1_1 to PX4_1. A description overlapping the above-described contents will be omitted.

The liquid crystal display device shown in FIGS. 14 and 15 is different from the liquid crystal display device shown in FIGS. 1 to 9 in that the shape of a pixel electrode is different. Hereinafter, the liquid crystal display according to still another exemplary embodiment of the present invention will be described with reference to the first pixel unit PX1_2 among first to fourth pixel units PX1_2 to PX4_2.

A first pixel electrode PE1_2 includes a first stem PE1a1_2 extending in the first direction d1, and a second stem PE1a2_2 extending in the second direction d2. That is, the first stem PE1a1_2 is a horizontal stem extending in a horizontal direction with reference to FIG. 14B, and the second stem PE1a2_2 is a vertical stems extending in the vertical direction with reference to FIG. 14B. In an exemplary embodiment, the first stem PE1a1_2 and the second stem PE1a2_2 may intersect each other. The second stem PE1a2_2 may overlap the first data line DL1_2.

The first pixel electrode PE1_2 may further include a plurality of first branches PE1b1_2, a plurality of second branches PE1b2_2, and a plurality of third branches PE1b3_2. The plurality of first branches PE1b1_2 and the plurality of second branches PE1b2_2 are defined as branches extending from the second stem PE1a2_2.

More specifically, the plurality of first branches PE1b1_2 are defined as branches disposed at one side of the second stem PE1a2_2 and extending in a direction in which a first edge bar PE1e to be described later is disposed, that is, substantially in first direction d1. The plurality of second branches PE1b2_2 are defined as branches disposed at the other side of the second stem PE1a2_2 and extending in a direction (substantially, the third direction d3) in which the first region G1 of storage line RL is disposed. The plurality of third branches PE1b3_2 are defined as branches extending from the first stem PE1a1_2. At least some of the plurality of first branches PE1b1_2 and the plurality of third branches PE1b3_2 may overlap the second data line DL2_2.

Meanwhile, the first pixel electrode PE1_2 may further include a first edge bar PE1e. The first edge bar PE1e may extend along the second direction d2, and may be in direct contact with the first stem PE1a1_2. The first edge bar PE1e may be disposed adjacent to the first branch PE1b1_2, which is longer than the second branch PE1b2_2. The first edge bar PE1e may at least partially overlap the second region G2 of the storage line RL.

In an exemplary embodiment, the distance 14 between the first edge bar PE1e and the second data line DL2_2 may be about 10 um or more. Further, the distance 13 between the first data line DL1_2 and the first region G1 of the storage line RL may be about 10 um to 15 um.

If the lengths of the branches included in the pixel electrode are relatively short, the liquid crystal control force is weak, so that an effect of improving visibility is small even when the edge bar is applied. In contrast, in the liquid crystal display device according to still another exemplary embodiment, the lengths of the plurality of first branches PE1b1_2 are longer than the lengths of the plurality of second branches PE1b2_2, and the first edge bar PE1e is disposed to be adjacent to the plurality of branches PE1b_2 while spaced from the second data line DL2_2 by a predetermined distance, thereby increasing the effect of improving visibility by the application of the edge bar.

That is, the edge bar of the pixel electrode may be disposed so as to be adjacent to the branches having relatively longer lengths. Accordingly, even if the shape of the branches of the pixel electrode changes, the edge bar may be disposed adjacent to the relatively longer branches. For example, the third pixel unit PX3_2 may be symmetric with the first pixel unit PX1_2 with respect to a first virtual line AL1. Further, the second pixel unit PX2_2 may be symmetrical with the fourth pixel unit PX4_2 with respect to the first virtual line AL1. Accordingly, the positions of the edge bars disposed in the respective pixel units may be different from each other.

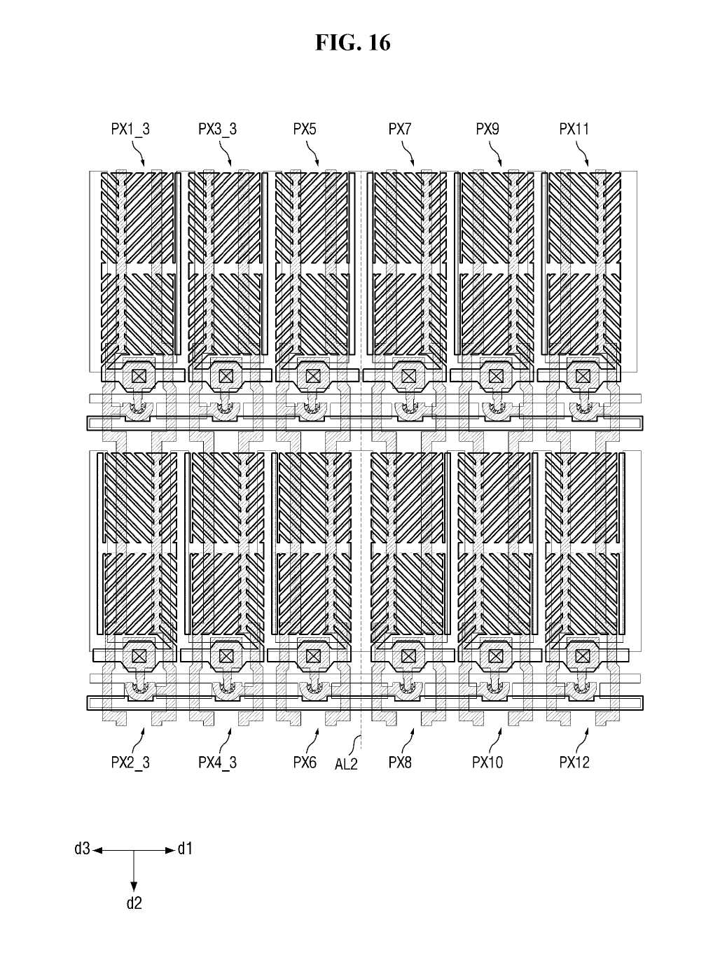

It is shown in FIG. 14A that the shape of the pixel electrode and the connection relationship between the switching element and the data line are periodically changed with respect to one pixel unit, but the present invention is not limited thereto. This will be described with reference to FIG. 16.

FIG. 16 is a layout view showing a liquid crystal display device according to another exemplary embodiment of the present invention.

Referring to FIG. 16, the shape of the pixel electrode and the connection relationship between the switching element and the data line are changed periodically with respect to three pixel units. For example, the first pixel unit PX1_3, the third pixel unit PX3_3, and the fifth pixel unit PX5 may have the same shape, and the seventh pixel unit PX7, the eighth pixel unit PX8, and the ninth pixel unit PX9 may have the same shape. However, the shapes of the first to third pixel units PX1_3 to PX3_3 and the shapes of the seventh to ninth pixel units PX7 to PX9 may be symmetrical to each other with respect to a second virtual line AL2. Further, the shapes of the pixel units arranged in the same column may be different from each other.

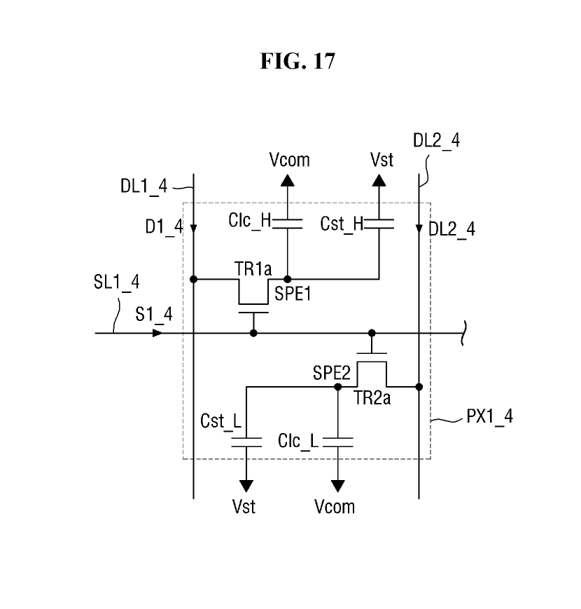

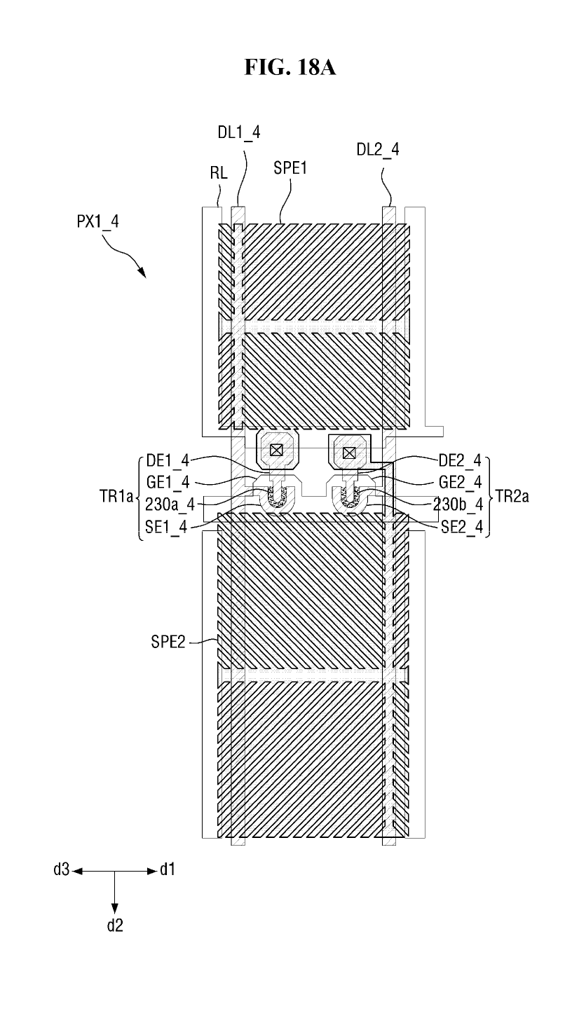

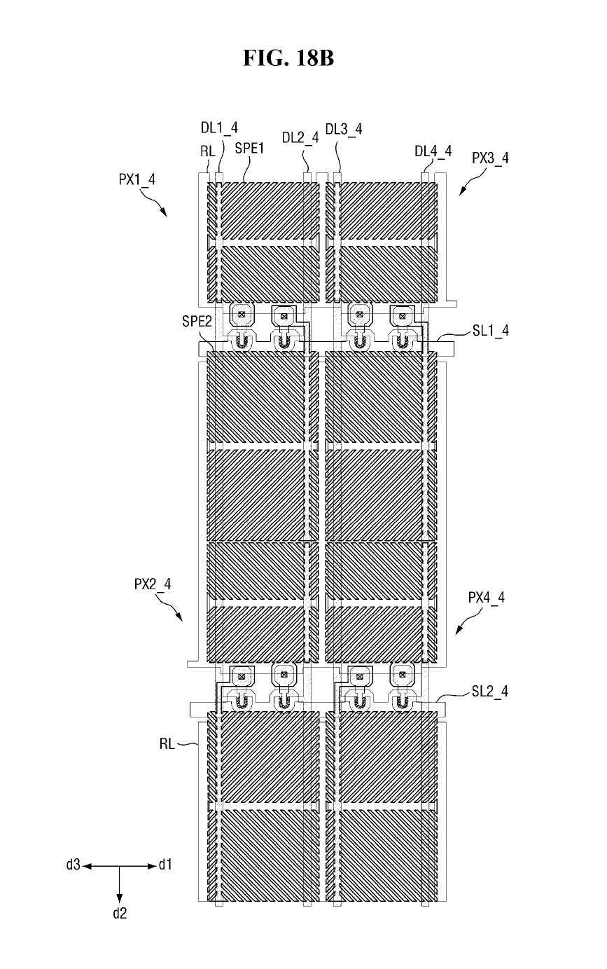

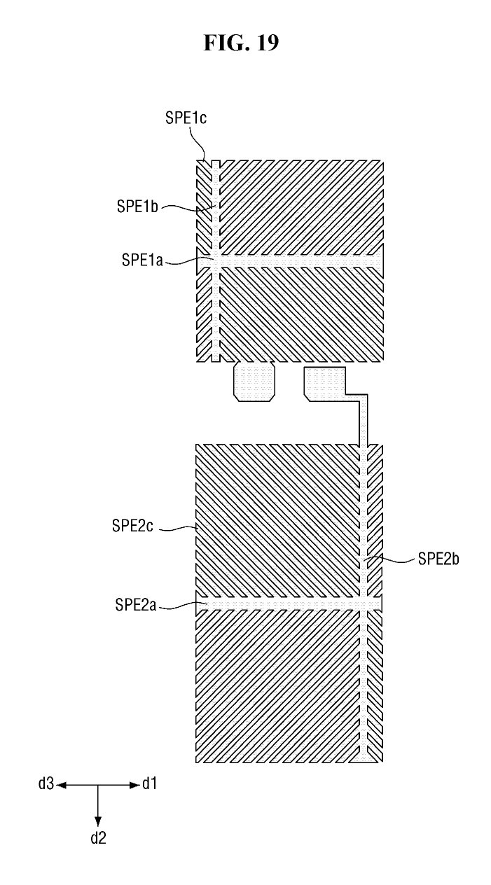

FIG. 17 is an equivalent circuit diagram of a first pixel unit included in a liquid crystal display device according to still another exemplary embodiment of the present invention. FIG. 18A is a layout view more specifically showing the first pixel unit shown in FIG. 17. FIG. 18B is a layout view showing first to fourth pixel units including the first pixel unit shown in FIG. 17. FIG. 19 is a view showing both a first sub-pixel electrode and a second sub-pixel electrode shown in FIG. 18A.

Referring to FIGS. 17 to 19, the configuration of first to fourth pixel units PX1_4 to PX4_4 will be described with reference to the first pixel unit PX1_4. Meanwhile, not only a first scan line SL1_4 and a second scan line SL2_4 but also a plurality of scan lines including the same are not electrically connected to each other.

The first pixel unit PX1_4 may include a first switching element TR1a, a second switching element TR2a, a first sub-pixel electrode SPE1, a second sub-pixel electrode SPE2, a first sub-liquid crystal capacitor Clc_H, a second sub-liquid crystal capacitor Clc_L, a first sub-storage capacitor Cst_H, and a second sub-storage capacitor Cst_L.

The first switching element TR1a may include a first gate electrode GE1_4 electrically connected to the first scan line SL1_4, a first source electrode SE1_4 electrically connected to the first data line DL1_4, and a first drain electrode DE1_4 electrically connected to the first sub-pixel electrode SPE1. Here, the first drain electrode DE1_4 of the first switching element TR1a may be electrically connected to the first sub-pixel electrode SPE1.

That is, the first switching element TR1a may perform a switching operation based on the first scan signal S1_4 received from the first scan line SL1_4 to provide the second data signal D2_4 received from the second data line DL2_4 to the first sub-pixel electrode SPE1.

The second switching element TR2a may include a second gate electrode GE2_4 electrically connected to the first scan line SL1_4, a second source electrode SE2_4 electrically connected to the first data line DL1_4, and a second drain electrode DE2_4 electrically connected to the second sub-pixel electrode SPE2. Here, the second drain electrode DE2_4 of the second switching element TR2a may be electrically connected to the second sub-pixel electrode SPE2.

That is, the second switching element TR2a may perform a switching operation based on the first scan signal S1_4 received from the first scan line SL1_4 to provide the second data signal D2_4 received from the second data line DL2_4 to the second sub-pixel electrode SPE2.

The first sub-liquid crystal capacitor Clc_H is formed between the first sub-pixel electrode SPE1 and the common electrode provided with the common voltage Vcom. Further, the second sub-liquid crystal capacitor Clc_L is formed between the second sub-pixel electrode SPE2 and the common electrode provided with the common voltage Vcom.

That is, the first pixel unit PX1_4 may include two sub-pixel electrodes receiving different data signals through a switching operation of two switching elements simultaneously turned on and electrically connected to different data lines. Accordingly, it is possible to control the arrangement of a plurality of liquid crystal molecules for each region in one pixel unit, thereby improving a lateral viewing angle.

The first sub-pixel electrode SPE1 and the second sub-pixel electrode SPE2 will now be described in more detail. In an embodiment, the area of the first sub-pixel electrode SPE1 may be smaller than the area of the second sub-pixel electrode SPE2.

The first sub-pixel electrode SPE1 may include a first stem SPE1a extending in the first direction d1, a second stem SPE1b extending in the second direction d2, and a plurality of first branches SPE1c.

The first stem SPE1a may intersect the first data line DL1_4 and the second data line DL2_4, respectively. Accordingly, the first stem SPE1a may include a region overlapping the first data line DL1_4 and a region overlapping the second data line DL2_4.

The second stem SPE1b may extend in the same direction as the first data line DL1_4, and may overlap the first data line DL1_4. Thus, the area of a dark portion due to the first data line DL1_4 can be minimized.

A plurality of first branches SPE1c may extend from at least one of the first stem SPE1a and the second stem SPE1b. More specifically, the plurality of first branches SPE1c may include a plurality of first sub-branches SPE1c_1 and a plurality of second sub-branches SPE1c_2 symmetrical to each other with respect to the first stem SPE1a. The plurality of first branches SPE1c may at least partially overlap the second data line DL2_4.

The second sub-pixel electrode SPE2 may include a first stem SPE2a extending in the first direction d1, a second stem SPE2b extending in the second direction d2, and a plurality of first branches SPE2c.

The first stem SPE2a may intersect the first data line DL1_4 and the second data line DL2_4, respectively. Accordingly, the first stem SPE2a may include a region overlapping the first data line DL1_4 and a region overlapping the second data line DL2_4.

The second stem SPE2b may extend in the same direction as the second data line DL2_4, and may overlap the second data line DL2_4. Thus, the area of a dark portion due to the second data line DL2_4 can be minimized. A plurality of first branches SPE2c may extend from at least one of the first stem SPE2a and the second stem SPE2b.

The second stem SPE2b may overlap the second data line DL2_4, unlike the second stem SPE1b of the first sub-pixel electrode SPE1. Accordingly, the second stem SPE1b of the first sub-pixel electrode SPE1 and the second stem SPE2b of the second sub-pixel electrode SPE2 are not disposed on the same line with respect to the second direction d2. Thus, the extension direction of the plurality of first branches SPE1c of the first sub-pixel electrode SPE1 and the extension direction of the plurality of first branches SPE2c of the second sub-pixel electrode SPE2 may be opposite to each other.

Meanwhile, between the pixel units arranged in the same row, the shapes of two sub-pixel electrodes may be the same as each other. That is, the shape of each of the two sub-pixel electrodes included in the first pixel unit PX1_4 may be the same as the shape of each of the two sub-pixel electrodes included in the second pixel unit PX2_4 disposed on the same row as the first pixel unit PX1_4. Further, the shape of each of the two sub-pixel electrodes included in the third pixel unit PX3_4 may be the same as the shape of each of the two sub-pixel electrodes included in the fourth pixel unit PX4_4 disposed on the same row as the third pixel unit PX3_4.

In contrast, between the pixel units arranged in the same column, the shapes of two sub-pixel electrodes may be different from each other. More specifically, the extension directions of the plurality of branches included in the sub-pixel electrode may be opposite to each other. That is, between the pixel units arranged in the same column, the plurality of branches included in the sub-pixel electrode may be arranged so that the extension directions thereof are staggered from each other.

As described above, according to exemplary embodiments of the present invention, it is possible to perform high-resolution driving and minimize the loss of an aperture ratio.

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A liquid crystal display device, comprising:
a first pixel electrode comprising a first stem extending in a first direction, a second stem connected to the first stem and extending in a second direction intersecting the first direction, a third stem connected to the first stem and extending in the second direction, a plurality of first branches extending from the second stem toward the third stem, and a plurality of second branches extending from the third stem toward the second stem;
a first data line extending in the second direction and overlapping the second stem;
a second data line extending in the second direction and overlapping the plurality of first branches and the plurality of second branches;
a first scan line extending in the first direction; and
a first switching element comprising a control electrode connected to the first scan line, a first electrode connected to the first data line, and a second electrode connected to the first pixel electrode.

2. The liquid crystal display device of claim 1, further comprising a storage line disposed on the same layer as the first scan line,
wherein at least a part of the storage line overlaps the second stem.

3. The liquid crystal display device of claim 2,
Wherein:
the first pixel electrode further comprises a plurality of branches extending in a direction symmetrical to the extension direction of the plurality of first branches;
the storage line comprises a first region overlapping the plurality of third branches and a second region overlapping the plurality of second branches; and
the first region does not overlap the first data line, and the second region does not overlap the second data line.

4. The liquid crystal display device of claim 3,
wherein a shortest distance between the first region and the first data line is equal to a shortest distance between the second region and the second data line.

5. The liquid crystal display device of claim 1,
wherein at least one of the first data line and the second data line includes a bent region, and at least a part of the bent region overlaps the first pixel electrode.

6. The liquid crystal display device of claim 1,
wherein the first pixel electrode further comprises a connection portion connected to the other electrode of the first switching element, and the connection portion overlaps at least one of the first data line and the second data line.

7. The liquid crystal display device of claim 1, further comprising:
a second scan line extending in the first direction;
a second pixel electrode disposed between the first scan line and the second scan line; and
a second switching element comprising a control electrode connected to the second scan line, a first electrode connected to the first data line, and a second electrode connected to the second pixel electrode,
wherein the first switching element and the second switching element perform a switching operation at the same time.

8. The liquid crystal display device of claim 7,
wherein the first scan line and the second scan line are electrically connected to each other.

9. A liquid crystal display device, comprising:
a first pixel electrode comprising a first stem extending in a first direction, a second stem connected to the first stem and extending in a second direction intersecting the first direction, a third stem connected to the first stem and extending in the second direction, a plurality of first branches extending from the second stem to be connected to the third stem, and a plurality of second branches extending from the third stem to extend in a direction symmetrical to the extension direction of the plurality of first branches;
a first data line extending in the second direction and overlapping the second stem; and
a second data line extending in the second direction and overlapping the third stem.

10. The liquid crystal display device of claim 9, further comprising:
a storage line surrounding the first pixel electrode,
wherein the first pixel electrode further comprises a plurality of third branches extending from the second stem to at least partially overlap the storage line.

11. The liquid crystal display device of claim 10,
wherein:
the storage line comprises a first region overlapping the plurality of third branches and a second region overlapping the plurality of second branches; and
the first region does not overlap the first data line, and the second region does not overlap the second data line.

12. The liquid crystal display device of claim 11,
wherein a shortest distance between the first region and the first data line is greater than a shortest distance between the second region and the second data line.

13. The liquid crystal display device of claim 9, further comprising:
a first scan line extending in the first direction; and
a second switching element comprising a control electrode connected to the first scan line, a first electrode connected to the first data line, and a second electrode connected to the first pixel electrode,
wherein the first pixel electrode further comprises a connection portion directly connected to the other electrode of the first switching element, and the connection portion overlaps at least one of the first data line and the second data line.

14. The liquid crystal display device of claim 9,
wherein at least one of the first data line and the second data line includes a bent region, and at least a part of the bent region overlaps the first pixel electrode.

15. A liquid crystal display device, comprising:
a first pixel electrode comprising a first stem extending in a first direction, a second stem connected to the first stem and extending in a second direction intersecting the first direction, an edge bar connected to the first stem and extending in the second direction, and a plurality of first branches extending from the second stem to extend in a direction in which the edge bar is disposed;
a first data line extending in the second direction and overlapping the second stem;
a second data line extending in the second direction and overlapping the plurality of first branches;
a first scan line extending in the first direction; and
a first switching element comprising a control electrode connected to the first scan line, a first electrode connected to the first data line, and a second electrode connected to the first pixel electrode.

16. The liquid crystal display device of claim 15, further comprising a second pixel electrode disposed adjacent the first pixel electrode in the second direction,
wherein a shape of the first pixel electrode is symmetrical to a shape of the second pixel electrode with respect to a virtual line extending in the first direction between the first pixel electrode and the second pixel electrode.

17. The liquid crystal display device of claim 16, further comprising:
a third pixel electrode disposed adjacent the first pixel electrode in the first direction,
wherein a shape of the first pixel electrode is symmetrical to a shape of the third pixel electrode with respect to a virtual line extending in the second direction between the first pixel electrode and the second pixel electrode.

18. The liquid crystal display device of claim 15, further comprising a storage line surrounding the first pixel electrode,
wherein at least a part of the edge bar overlaps the storage line.

19. The liquid crystal display device of claim 15,
wherein at least one of the first data line and the second data line includes a bent region, and at least a part of the bent region overlaps the first pixel electrode.

20. The liquid crystal display device of claim 15,
wherein the first pixel electrode further comprises a connection portion directly connected to the other electrode of the first switching element, and the connection portion overlaps at least one of the first data line and the second data line.
